(19) United States
(12) Patent Application Publication
(10) Pub. No.: US 2026/0032696 A1
(43) Pub. Date: Jan. 29, 2026

(54) SYSTEMS AND METHODS FOR CELLULAR INTERNET OF THINGS (IOT)

(71) Applicant: ZTE CORPORATION, Shenzhen (CN)

(72) Inventors: Li NIU, Shenzhen (CN); Bo DAI, Shenzhen (CN); Ting LU, Shenzhen (CN); Yuan GAO, Shenzhen (CN)

(73) Assignee: ZTE CORPORATION, Shenzhen (CN)

(21) Appl. No.: 19/344,912

(22) Filed: Sep. 30, 2025

Related U.S. Application Data
(63) Continuation of application No. PCT/CN2023/086719, filed on Apr. 6, 2023.

(51) Int. Cl. H04W 72/231; H04W 68/02; H04W 76/20

(52) U.S. Cl. CPC H04W 72/231; H04W 68/02; H04W 76/20

(57) ABSTRACT

Presented are systems and methods for cellular Internet of things (IoT). A wireless communication device may receive a signal from a wireless communication node. The wireless communication device may determine that information carried in the signal matches specific information. The wireless communication device may transition a radio from sleep state to wake-up state in response to the determination.

### CROSS-REFERENCE TO RELATED APPLICATIONS

This application claims the benefit of priority under 35 U.S.C. § 120 as a continuation of PCT Patent Application No. PCT/CN2023/086719, filed on Apr. 6, 2023, the disclosure of which is incorporated herein by reference in its entirety.

### TECHNICAL FIELD

The disclosure relates generally to wireless communications, including but not limited to systems and methods for cellular Internet of things (IoT).

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication device (e.g., a UE) may receive a signal (e.g., a wake up signal (WUS)) from a wireless communication node (e.g., a BS). The wireless communication device may determine that information carried in the signal (e.g., paging occasion (PO) information, a group ID, or an identifier of a UE) matches specific information (e.g., associated with the wireless communication device). The wireless communication device may transition a radio from sleep state to wake-up state (e.g., to measure synchronization signal block (SSB) or to monitor physical downlink control channel (PDCCH) for paging message) in response to the determination.

In some embodiments, the information carried in the signal comprises information can be about a specific paging occasion (PO). The information about the specific PO may comprise: an index of a paging frame (PF), and an index of the specific PO in the PF. The information about the specific PO may comprise: an index of the specific PO in a discontinuous reception (DRX) cycle.

In some embodiments, the information carried in the signal comprises information can be about a specific identifier (group ID) of a group of wireless communication devices that includes the wireless communication device. The wireless communication node may allocate the group ID. The wireless communication node may send the group ID to the wireless communication device via radio resource control (RRC) signaling. The wireless communication node may send the group ID to a core network. A core network may send the group ID to the wireless communication node.

In some embodiments, the information carried in the signal may comprise information about a specific identifier (group ID) of a group of wireless communication devices that includes the wireless communication device. The group ID can be allocated by a core network (CN), for a CN controlled subgroup associated with a paging Early Indication (PEI) of the wireless communication device. The group ID can be determined, based on UE ID associated with the PEI of the wireless communication device.

In some embodiments, the information carried in the signal may comprise information about a specific identity of the wireless communication device, or a part of the specific identity. The specific identifier may comprise a serving temporary mobile subscriber identity (S-TMSI). The wireless communication node may allocate the specific identity, and may send the specific identity to the wireless communication device via radio resource control (RRC) signaling.

In some embodiments, the wireless communication device may receive, from the wireless communication node via the signal (e.g., low power wake up signal (LP-WUS)), a system information block (SIB) or radio resource control (RRC) signaling, configuration information of a paging occasion (PO) or physical downlink control channel (PDCCH) for the wireless communication device to monitor for paging. In certain embodiments, an additional PO and/or PUCCH may be received if specific PO is missed due to ramp-up time.

In some embodiments, the configuration information may comprise at least one of: an offset between a starting or ending time of the signal and a starting time of the PO or PDCCH, an offset between the starting or ending time of the signal and a starting time of a discontinuous reception (DRX) cycle, an offset between the starting or ending time of the signal and a starting time of a paging frame (PF), a duration of the PDCCH, an indication of a resource configured for the PO or PDCCH, an indication of a configuration for enabling the PO or PDCCH, carried in RRC or SIB signaling, an index of the PF, and an index of the PO in the PF, an index of the PO in the DRX cycle, an index of the PO in a PF, a system frame number (SFN) of the PF, and the index of the PO in the PF, the SFN of the PF, and a slot number of the PO, or a SFN of the PO, and the slot number of the PO. The LP-WUS may indicate a PO resource that the UE monitors. The LP-WUS may indicate a PDCCH resource for paging that the UE monitors.

In some embodiments, the DRX cycle can be a DRX cycle that is nearest to the time that the wireless communication device has completed transition to wake up state. The DRX cycle can be determined by a first offset time. The PF can be a PF that is nearest to the time that the wireless communication device has completed transition to wake up state. The PF can be determined by a second offset time. The PO can be a PO that is nearest to the time that the wireless communication device has completed transition to wake up state. The PO can be determined by a third offset time. The PO can be determined by the third offset time and an identity of the wireless communication device, and the PF can be shifted by the third offset time. The PDCCH can be a PDCCH that is nearest to the time that the wireless communication device has completed transition to wake up state. The PDCCH can be determined by a fifth offset time.

In some embodiments, the wireless communication device may receive, from the wireless communication node via the signal, information about a physical downlink shared channel (PDSCH) resource or downlink grant for PDSCH, for the wireless communication device to monitor for paging. The wireless communication device may receive, from the wireless communication node via the signal, a system information block (SIB) or radio resource control (RRC) signaling, an indicator to enable or disable the wireless communication device to monitor the PO or PDCCH for paging.

In some embodiments, the wireless communication device may monitor a separate PO or PDCCH for paging. The wireless communication device may monitor a separate PO for paging, if the wireless communication device fails to detect paging in the PO or PDCCH. The wireless communication device may transition into a deep sleep state, if the wireless communication device fails to detect paging after monitoring at least a defined number of POs.

In some embodiments, the wireless communication device may receive, from the wireless communication node via the signal, a system information block (SIB) or radio resource control (RRC) signaling, configuration information of a physical random access channel (PRACH) resource or a PRACH resource pool to be used for measurement of a synchronization block (SSB), after receiving the signal. The wireless communication device may select the PRACH resource from the PRACH resource pool, according to an index of the wireless communication device, the index included in a list of indices of wireless communication devices woken by the signal.

In some embodiments, if the wireless communication device is woken up by the signal, an access stratum (AS) may send an indication to a non-access stratum (NAS) that the wireless communication device is woken up by the signal. If a radio resource control (RRC) connection is triggered by the signal, the NAS may send to the AS an indication that mobile termination is triggered by the signal. The wireless communication device may send a msg3 to the wireless communication node, the msg3 indicating an establishment cause or establishment indication that mobile termination is triggered by the signal. The wireless communication node may send a msg4 to the wireless communication node, the msg4 indicating a rejection cause or rejection indication that the mobile termination is triggered by the signal. If the RRC connection is rejected, the AS may send an indication of the rejection cause or rejection indication to the NAS, to indicate that the wireless communication device is incorrectly woken up by the signal.

In some embodiments, the signal may include an indication that system information has been updated. The wireless communication device may send, to a core network (CN), an indication of a capability of the wireless communication device to operationally respond to the signal. The CN may send the indication of the capability to the wireless communication node.

In some embodiments, a wireless communication node (e.g., a BS) may send a signal (e.g., a WUS) to a wireless communication device (e.g., a UE). The wireless communication device may determine that information carried in the signal (e.g., paging occasion (PO) information, a group ID, or an identifier of a UE) matches specific information (e.g., associated with the wireless communication device). The wireless communication device may transition a radio from sleep state to wake-up state (e.g., to measure synchronization signal block (SSB) or to monitor physical downlink control channel (PDCCH) for paging message) in response to the determination.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example implementation of cellular Internet of things (IoT), in accordance with some embodiments of the present disclosure;

FIG. 4 illustrates an example implementation of cellular Internet of things (IoT), in accordance with some embodiments of the present disclosure;

FIG. 5 illustrates an example implementation of cellular Internet of things (IoT), in accordance with some embodiments of the present disclosure;

FIG. 6 illustrates an example implementation of cellular Internet of things (IoT), in accordance with some embodiments of the present disclosure;

FIG. 7 illustrates an example implementation of cellular Internet of things (IoT), in accordance with some embodiments of the present disclosure;

FIG. 8 illustrates an example implementation of cellular Internet of things (IoT), in accordance with some embodiments of the present disclosure;

FIG. 9 illustrates an example implementation of cellular Internet of things (IoT), in accordance with some embodiments of the present disclosure; and

FIG. 10 illustrates a flow diagram of an example method for cellular Internet of things (IoT), in accordance with an embodiment of the present disclosure.

### DETAILED DESCRIPTION

### 1. Mobile Communication Technology and Environment

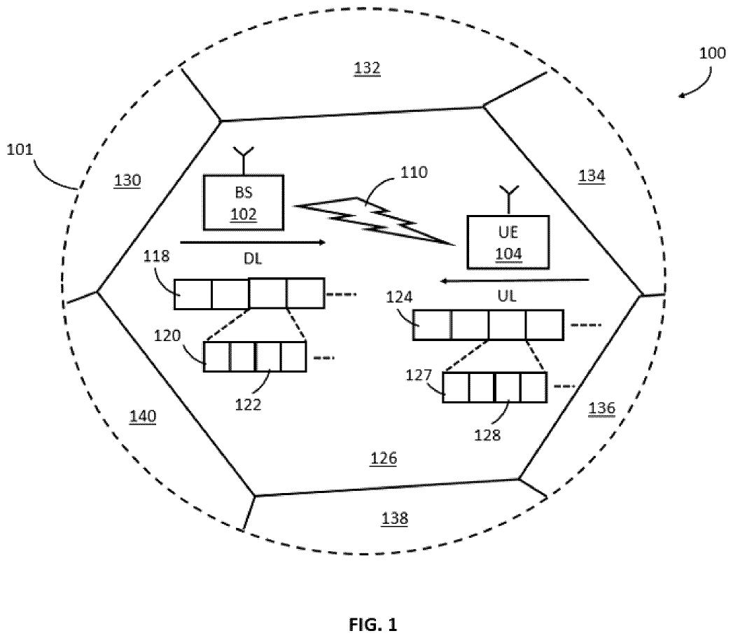

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

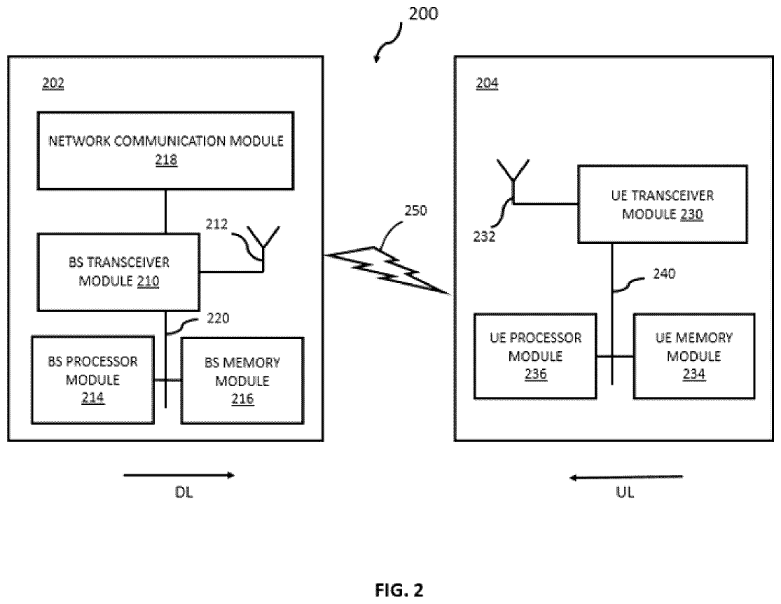

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Cellular Internet of Things (IoT)

5G systems can be designed and developed targeting for both mobile telephony and vertical use cases. Besides latency, reliability, and availability, UE energy efficiency can be also critical to 5G. Currently, 5G devices may have to be recharged per week or day, depending on individual's usage time. 5G devices may consume tens of milliwatts in radio resource control (RRC) idle/inactive state and hundreds of milliwatts in RRC connected state. Designs to prolong battery life can be performed for improving energy efficiency as well as for better user experience.

Energy efficiency is even more critical for UEs without a continuous energy source, e.g., UEs using small rechargeable and single coin cell batteries. Among vertical use cases, sensors and actuators can be deployed extensively for monitoring, measuring, and/or charging. Their batteries may not be rechargeable and expected to last at least few years. Wearables may include smart watches, rings, eHealth related devices, and/or medical monitoring devices. With a typical battery capacity, it may be challenging to sustain up to 1-2 weeks as required.

The power consumption may depend on a configured length of wake-up periods, e.g., a paging cycle. To meet the battery life requirements above, an extended discontinuous reception (eDRX) cycle with large value can be expected to be used, resulting in high latency, which is not suitable for such services with requirements of both long battery life and low latency. For example, in fire detection and extinguishment use case, fire shutters can be closed and fire sprinklers can be turned on by actuators within 1 to 2 seconds from the time the fire is detected by sensors. A long eDRX cycle cannot meet the delay requirements. eDRX may not be suitable for latency-critical use cases. Thus, an ultra-low power mechanism that can support low latency can be performed (e.g., lower than eDRX latency).

Currently, UEs may periodically wake up once per DRX cycle, which dominates the power consumption in periods with no signaling or data traffic. If UEs are able to wake up only when they are triggered (e.g., paging), power consumption can be dramatically reduced. This can be achieved by using a wake-up signal to trigger the main radio and a separate receiver which has the ability to monitor wake-up signal with ultra-low power consumption. Main radio works for data transmission and reception can be turned off or can set to deep sleep unless the UE is turned on. In present disclosure, methods and systems for a low-power wake up signal (WUS)/wake up receiver (WUR) for power-sensitive, small form-factor devices including IoT use cases (e.g., industrial sensors, controllers) and wearables can be performed.

A low power-wake up signal (LP-WUS) may include a wake up signal or a synchronization signal. A UE may receive the LP-WUS when the UE falls into deep sleep mode. The wake up signal can be used for a gNB to wake a UE up. When the UE detects the signal, the UE may wake up from the deep sleep mode. The UE may receive a synchronization signal block (SSB) signal, may perform measurements, and/or may receive paging after the UE wakes up. The synchronization signal can be used for a gNB to supply synchronization information for a UE. The UE can obtain synchronization information, and/or can perform measurement based on the synchronization signal.

### Implementation Example 1: Group

A LP-WUS can be used to wake up a UE that enters into deep sleep for power saving. A LP-WUS may wake up a group of UEs. The LP-WUS may carry information about the group of UEs.

In some embodiments, a group of UEs can be grouped by a UE ID and related with paging occasion (PO). The LP-WUS may carry the information about the PO. A paging frame (PF) and PO for paging can be determined by the UE ID. The LP-WUS may carry the information about the PO, such as an index of PF and an index of PO in PF, and/or an index of PO in a DRX. Each DRX cycle may include a plurality of PFs. Each PF may include a plurality of POs. To locate a particular PO, the UE may locate a specific PF which includes the PO.

In a DRX cycle, it may include one or more paging frames (PFs). The number of total PFs in a DRX cycle (e.g., N) can be indicated in a system information block (SIB). The PF index can be an index of PF within number of total PFs in a DRX cycle. If a PF index is indicated, the UE can determine which PF in a DRX cycle. One PF may include one or more PO(s). The number of total POs in a PF (e.g., Ns) can be indicated in a SIB. The PO index in a PF can be an index of PO within number of total POs in a PF. If a PO index is indicated, the UE may determine which PO in a PF. Hence, the index of PF and the index of PO in PF can indicate a PO in a DRX.

Alternatively, the number of total PFs in a DRX cycle (e.g., N) and the number of total POs in a PF (e.g., Ns) may deduce the total number of POs in a DRX cycle (e.g., N*Ns). The PO index in a DRX can be an index of PO within the total number of POs in a DRX. If a PO index is indicated, the UE can determine which PO in a DRX. Hence, the index of PO in a DRX can indicate a PO in a DRX.

If the UE detects the LP-WUS, and its PO matches with the information about the PO, the UE may wake up, and may start to measure SSB or monitor PDCCH for paging.

In some embodiments, a group of UEs can be grouped by a gNB. The LP-WUS can carry a group ID allocated by the gNB. When a UE enters into a connected mode, the gNB may allocate a group ID about LP-WUS for the UE via a RRC message, such as a RRC release message. The LP-WUS may carry a group ID about LP-WUS. If the UE detects the LP-WUS, and its allocated group ID matches with the group ID carried in LP-WUS, the UE may wake up, and may start to measure SSB or to monitor PDCCH for paging.

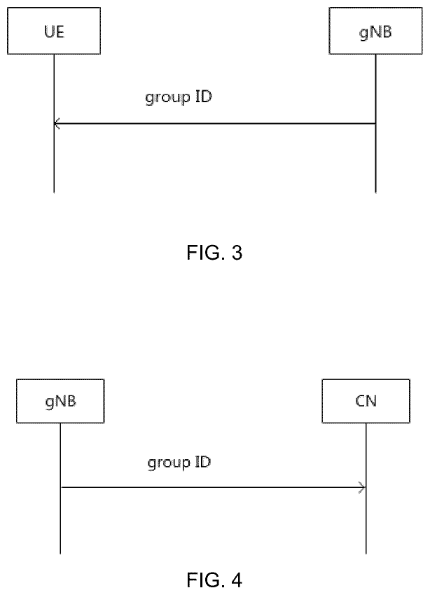

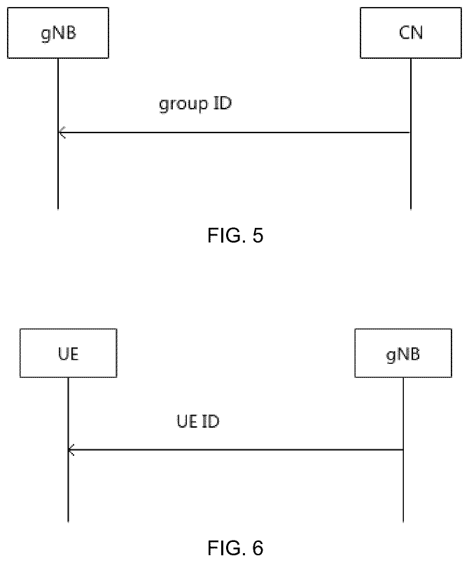

FIGS. 3-5 illustrate an example implementation of cellular Internet of things (IoT), in accordance with some embodiments of the present disclosure. If a gNB allocates a group ID for UEs, the gNB may deliver the group ID of the UEs to a core network. When the core network pages a UE, the core network may deliver a corresponding group ID of the UE to the gNB. The gNB may deliver a group ID of UEs to the core network via a NG message, e.g. UE history information, and/or UE radio capabilities. The CN can deliver a group ID of UEs to the gNB and/or UEs via a NG message (e.g., paging).

In some embodiments, a group of UEs that are grouped by a CN controlled subgrouping for paging early indication (PEI). A LP-WUS may carry the group ID allocated by the CN controlled subgrouping for PEI. The group of UEs monitoring the same PO can be further divided into multiple subgroups by the CN controlled subgrouping. For CN controlled subgrouping, an access & mobility management function (AMF) can be responsible for assigning subgroup ID to the UE. The LP-WUS can carry the group ID of CN controlled subgrouping for PEI. If the UE detects the LP-WUS, and its allocated group ID matches with the group ID carried in LP-WUS, the UE may wake up, and may start to measure SSB or to monitor PDCCH for paging.

In some embodiments, a group of UEs that are grouped by a UE ID based subgrouping for PEI. A LP-WUS may carry the group ID allocated by UE ID based subgrouping for PEI. The group of UEs monitoring the same PO can be further divided into multiple subgroups by UE ID based subgrouping. The gNB and/or UE can determine the subgroup ID based on the UE ID. The LP-WUS may carry the group ID of UE ID based subgrouping for PEI. If the UE detects the LP-WUS, and its group ID matches with the group ID carried in LP-WUS, the UE may wake up, and may start to measure SSB or to monitor PDCCH for paging.

A LP-WUS may indicate UE information. The UE information may include the UE identity or a part of UE identity, such as a serving temporary mobile subscriber identity (S-TMSI), a part of the S-TMSI. A part of UE identity may be a mask of UE identity. Alternatively, when a UE enters into the connected mode, a gNB may allocate a UE ID/identity for the UE via a RRC message, such as a RRC release message. If the UE detects the LP-WUS, and its UE identity matches with the UE identity carried in LP-WUS, the UE may wake up, and may start to measure SSB or to monitor PDCCH for paging.

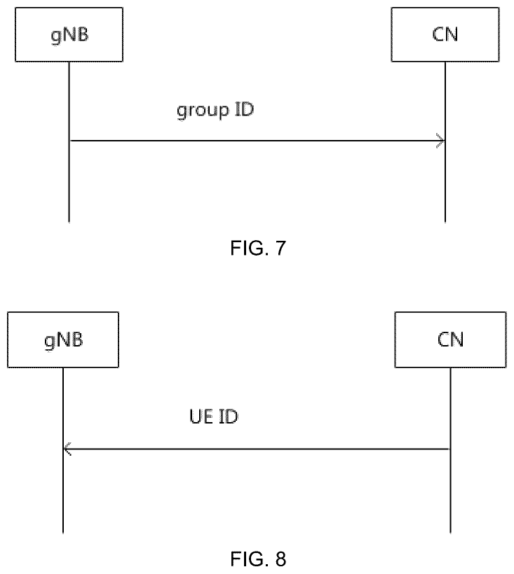

FIGS. 6-8 illustrate an example implementation of cellular Internet of things (IoT), in accordance with some embodiments of the present disclosure. If a gNB allocates a UE ID for a UE, the gNB may deliver the UE ID of the UE to a core network. When the core network pages a UE, the core network may deliver the corresponding UE ID to the gNB. The gNB may deliver a UE ID of the UE to the core network via a NG message, such as UE history information, or UE radio capabilities. The CN may deliver a UE ID of UEs to the core network via a NG message, such as paging.

### Implementation Example 2: Additional PO

When a UE in deep sleep is woken up by a LP-WUS, a ramp-up time may reach 400 ms. The ramp-up time may delay the time that the UE monitors PO. After the UE wakes up, the UE may have to measure SSB to obtain synchronization, may monitor PDCCH for paging, and may initiate a random access channel (RACH). Hence, the access to the cell may be delayed.

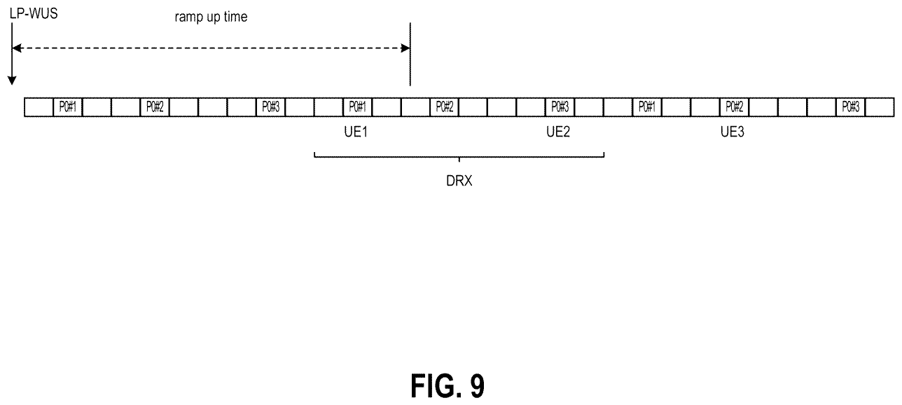

FIG. 9 illustrates an example implementation of cellular Internet of things (IoT), in accordance with some embodiments of the present disclosure. As illustrated in FIG. 9, a UE 1 and a UE 2 can be woken up by a LP-WUS. After ramp up time, they may start to monitor a paging occasion (PO). In some embodiments, the UE1 may miss its PO after ramp up time, and the UE1 may wait for PO in next DRX. This may delay a paging reception and an access to a cell.

In order to decrease the delay, a possible solution can be that a UE may monitor an additional PO. The additional PO can be determined as at least one of below.

In some embodiments, a RRC message or SIB may be configured or broadcasted a configuration of PO or PDCCH after LP-WUS. The RRC message or SIB may be configured or broadcasted a time resource configuration of PO or PDCCH. The configuration may include an offset between a starting or end time of LP-WUS and a starting time of PO or PDCCH, or nearest PO or PDCCH, the duration, period. If the UE receives the LP-WUS, the UE may monitor the PO or PDCCH according the configuration. The RRC message or SIB can be configured or broadcasted the frequency resource configuration of PO or PDCCH. The configuration may include at least one of: a frequency or a bandwidth.

In some embodiments, a LP-WUS may indicate a PO resource that the UE monitors. The LP-WUS may carry information about the PO, such as an index of PF and an index of PO in PF, or an index of PO in DRX. In a DRX cycle, it may include one or more paging frames (PFs). The number of total PFs in a DRX cycle (e.g., N) can be indicated in SIB. The PF index can be an index of PF within number of total PFs in a DRX cycle. If a PF index is indicated, the UE may determine which PF in a DRX cycle. A PF may include one or more PO(s). The number of total POs in a PF (e.g., Ns) can be indicated in SIB. The PO index in a PF can be an index of PO within number of total POs in a PF. If a PO index is indicated, the UE may determine which PO in a PF. Hence, the index of PF and the index of PO in PF may indicate a PO in a DRX. Alternatively, the number of total PFs in a DRX cycle (e.g., N) and the number of total POs in a PF (e.g., Ns) may deduce the number of total PO in a DRX cycle (e.g., N*Ns). The PO index in a DRX can be an index of PO within number of total POs in a DRX. If a PO index is indicated, the UE may determine which PO in a DRX. Hence, the index of PO in a DRX may indicate a PO in a DRX. Besides, the information about DRX may be indicated explicitly or implicitly. The DRX where PO locates can be the nearest DRX after the ramp up time. The LP-WUS can carry the information about the DRX for PO, for example, an offset between the starting or end time of LP-WUS and the starting time of DRX. The RRC message or SIB may configure or broadcast the offset between the starting or end time of LP-WUS and the starting time of DRX.

In some embodiments, a LP-WUS may indicate a PO resource that the UE monitors. The LP-WUS may carry the information about the PO, for example, a SFN of starting time of a PF and the index of PO in PF, a SFN of PF and the slot of PO, or a SFN and the slot of PO.

Alternatively, the SFN of PF can be a SFN of starting time of PF. If the SFN of PF is indicated, the UE may determine which PF. Hence, the SFN of PF and the index of PO in PF may indicate a PO. Alternatively, the slot of PO can be a slot of starting time of PO in a SFN. If the slot of PO is indicated, the UE may determine which PO. Hence, the SFN of PF and the slot of PO may indicate a PO in a DRX. Alternatively, the SFN and slot of PO can be a SFN and slot of stating time PO.

In some embodiments, the LP-WUS may carry the information about the PO, for example, the index of PO in PF. Besides, the information about PF may be indicated explicitly or implicitly. The PF where PO locates can be the nearest PF after the ramp up time. Alternatively, the LP-WUS may carry the information about the PF for PO, for example, an offset between the starting or end time of LP-WUS and the starting time of PF. Alternatively, a RRC message or SIB may configure or broadcast an offset between the starting or end time of LP-WUS and the starting time of PF.

In some embodiments, the LP-WUS may carry the information enabling PO, for example, an indicating enabling PO or the configuration of RRC or SIB. If the UE receives the LP-WUS carrying an indicating enabling additional PO or the configuration of RRC or SIB, the UE may monitor the PO.

In some embodiments, the LP-WUS may indicate a PDCCH resource for paging that the UE monitors. The LP-WUS may carry the information about the PDCCH, for example, an offset between the starting or end time of LP-WUS and the starting time of PDCCH, a duration of PDCCH. Alternatively, the RRC or SIB may configure or broadcast the PDCCH configuration for paging after LP-WUS. The configuration may include at least one of: an offset between the starting or end time of LP-WUS and the starting time of PDCCH, a duration of PDCCH, a period of PDCCH, or an index of PDCCH. The LP-WUS may carry the information enabling PDCCH, for example, a indicating enabling PDCCH, or an index of PDCCH. If the UE receives the LP-WUS carrying PDCCH resource, the UE may monitor this PDCCH.

In some embodiments, the LP-WUS may indicate a PDSCH resource for paging. The LP-WUS may carry the information about the DL grant for paging, for example, PDSCH frequency resource allocation, PDSCH time resource allocation, MCS, TPC command for PDSCH. The time resource of PDSCH may include an offset between the starting or end time of LP-WUS and the starting time of PDSCH. If UE receives the LP-WUS carrying PDSCH resource, the UE may receive this PDSCH.

### Implementation Example 3

A UE may determine an additional paging occasion (PO) after a LP-WUS. The additional PO can be determined as below.

In some embodiments, a RRC message or SIB may configure or broadcast an offset time between time of LP-WUS and time of PO. The time of LP-WUS may be the ending or starting time of LP-WUS. The time of PO may be the starting time of PO or nearest PO.

In some embodiments, a RRC message or SIB may configure or broadcast an indication that enabling additional PO. The indication may indicate whether the UE can monitor additional PO. Alternatively, the indication can indicate whether the UE can monitor additional PO and a separate PO (e.g., legacy PO).

In some embodiments, the PO can be determined by offset time2 and a UE ID. If the UE misses the legacy PO after ramp up time or offset time after LP-WUS, the UE may be distributed into the POs after ramp up time or offset time after LP-WUS based on UE ID. If the offset time2 is between ramp up time or offset time after LP-WUS and the starting time of DRX or offset used for PF determination (e.g., PF_offset), the additional PO may be shifted after offset time2. The SFN for the PF can be determined by: (SFN+PF_offset+offset time2) mod T=(T div N)*(UE_ID mod N).

### Implementation Example 4

If the UE is woken up by a LP-WUS, the UE may monitor additional PO. In order to guarantee that the UE can receive paging, the UE may monitor additional PO as above and a separate PO (e.g., legacy PO).

If the UE is woken up by a LP-WUS, the UE may monitor additional PO as above. If the UE fails to receive paging, for example, the UE fails to receive paging according to the information as above, the UE may continue to monitor paging in its legacy PO. If the UE receives the LP-WUS and matches the information in LP-WUS, the UE may receive the paging message according to the configuration of LP-WUS or information carried in LP-WUS. If the UE fails, the UE may continue to monitor paging in its legacy PO that is determined based on UE identity. If the UE couldn't receive the paging message in its legacy PO, the UE may enter into deep sleep mode.

If the UE is woken up by a LP-WUS, the UE may fail to receive paging in N continuous PO. The UE may enter into deep sleep mode. The value of N may be configured by a RRC message or SIB. If the UE receives the LP-WUS and matches the information in LP-WUS, the UE may receive the paging message in the N continuous additional PO and legacy PO. If the UE couldn't receive the paging message, the UE may enter into deep sleep mode.

### Implementation Example 5: Indicate RACH

When the UE in deep sleep is woken up by a LP-WUS, the ramp-up time may reach 400 ms. The ramp-up time may delay the time that the UE triggers RACH. After the UE wakes up, the UE may measure SSB to obtain synchronization, may monitor PDCCH for paging, and may initiate a RACH. Hence, the access to the cell may be delayed.

In order to decrease the delay, the possible solution can be at least one of followings.

In some embodiments, a RRC or SIB may configure or broadcast a configuration of physical random access channel (PRACH) or PRACH pool that is used after the LP-WUS. The configuration may include the resource of PRACH or resource pool of PRACH. The resource may include one or more random access preamble index, or PRACH mask index. The resource may also include the offset between the starting or end time of LP-WUS, the starting time of PRACH, the starting time of PRACH, a duration of PRACH, a periodicity of PRACH, and/or an index or list of PRACH configuration. The LP-WUS may carry the information enabling PRACH, for example, an indicating enabling PRACH, or an index of PRACH.

In some embodiments, a LP-WUS may indicate a PRACH resource for the UE. The LP-WUS may carry the information about the PRACH, for example, random access preamble index, PRACH mask index, a offset between the starting or end time of LP-WUS and the starting time of PDCCH, the starting time of PRACH, the starting time of PRACH, a duration of PRACH, a periodicity of PRACH, or an index of PRACH. If the UE receives the LP-WUS carrying RACH resource, the UE may select a PRACH resource to transmit preamble.

In some embodiments, if LP-WUS may wake up a group of UEs (e.g., a list of UE ID), the UE may select a PRACH resource from the resource pool of PRACH based on the UE index in the list (e.g., in ascending order of the UE index to select PRACH resource with higher index).

### Implementation Example 6: Establishment Cause

If the UE is falsely woken up, the gNB may recognize the UE. The gNB may refuse the UE access via an Msg4, and may avoid a false RRC establishment. For example, if the UE is falsely woken up, a RRC connection can be set up. Since there is no data transmission, the UE may be released. This procedure is unnecessary. Hence, the gNB may refuse the UE that is falsely woken up via the Msg4.

In order to support this, the gNB may recognize such a falsely awakened UE. The possible solution can be at least one of followings.

In some embodiments, if a UE is woken up by a LP-WUS, the access stratum (AS) may indicate it to a non-access stratum (NAS). If the UE receives a LP-WUS, and matches the information carried in the LP-WUS, the AS may indicate it to the NAS.

In some embodiments, if a RRC connection is triggered, the NAS may indicate to the AS that the mobile termination is triggered by the LP-WUS. If the UE receives the LP-WUS, matches the information carried in the LP-WUS, and triggers a RRC connection setup procedure, the NAS may indicate to the AS the establishment cause or establishment indication, and the establishment cause or establishment indication is that mobile termination is triggered by the LP-WUS.

In some embodiments, the UE may indicate an establishment cause or establishment indication in an msg3, to attribute to a LP-WUS. If the UE receives LP-WUS, matches the information carried in LP-WUS, in the msg3 (e.g., RRCSetupRequest RRCResumeRequest), the establishment cause or establishment indication can indicate that the establishment cause is that mobile termination is triggered by the LP-WUS.

In some embodiments, the gNB may indicate a reject cause or reject indication in a msg4 for a LP-WUS. If the gNB determines the UE is woken up falsely by a LP-WUS, the gNB may indicate the reject cause or reject indication in a msg4 (e.g., RRC reject), the reject cause or reject indication may indicate that the UE is woken up falsely by the LP-WUS.

In some embodiments, if a RRC connection is rejected, the AS may indicate to the NAS the reject cause or reject indication. The reject cause or reject indication may indicate that UE is woken up falsely by a LP-WUS.

### Implementation Example 7: Information

The LP-WUS may carry some information to assist a UE. The information can be at least one of: a beam index, a cell identity, or a system information change indication. When the UE receives a LP-WUS, according to the beam index carried in the LP-WUS, the UE may determine a current serving beam. When the UE receives a LP-WUS, according to the cell identity carried in the LP-WUS, the UE may determine a current serving cell. When the UE receives a LP-WUS and the LP-WUS indicates that system information is updated, the UE may receive system information.

### Implementation Example 8: UE Capability

A UE may report its capability about LP-WUS to a network, such as a gNB or a core network. The core network may deliver UE capability about LP-WUS to the gNB. The gNB may deliver UE capability about LP-WUS to the gNB.

The UE capability about the LP-WUS may include at least one of: whether to support LP-WUS (e.g., whether the UE can detect LP-WUS in idle or inactive mode, or whether the UE can detect LP-WUS in connected mode); whether to support cell measurement based on the LP-WUS (e.g., whether the UE can support relaxed serving cell measurement or neighbor cell measurement based on the LP-WUS in idle or inactive mode, or whether the UE can support the condition of starting or stopping serving cell measurement or neighbor cell measurement based on the LP-WUS in idle or inactive mode); whether to support cell selection based on the LP-WUS (e.g., whether the UE can support cell selection that prioritizing the cell that supporting the LP-WUS in idle or inactive mode); whether to support group LP-WUS (e.g., whether the UE can support group LP-WUS based on CN controlled grouping or UE ID based grouping for PEI or PO in idle or inactive mode); whether to support UE special LP-WUS (e.g., whether the UE can support UE special LP-WUS that is allocated by the gNB); or whether to support LP-WUS indicating PO or PDSCH or PDCCH or PRACH resource (e.g., whether the UE can receive the PO or PDSCH or PDCCH or PRACH resource carried in LP-WUS, and receive paging according to the PO or PDSCH or PDCCH resource or transmit PRACH according to the PRACH resource).

It should be understood that one or more features from the above implementation examples are not exclusive to the specific implementation examples, but can be combined in any manner (e.g., in any priority and/or order, concurrently or otherwise).

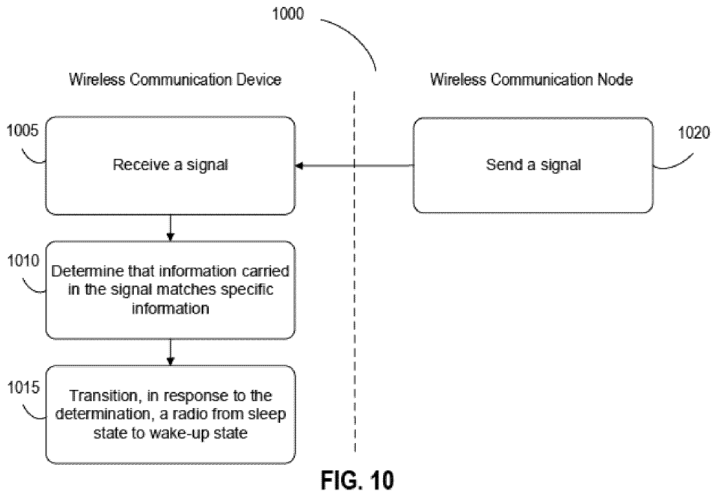

FIG. 10 illustrates a flow diagram of a method 1000 for carrier phase positioning. The method 1000 may be implemented using any one or more of the components and devices detailed herein in conjunction with FIGS. 1-2. In overview, the method 1000 may be performed by a wireless communication device (e.g., a UE), in some embodiments. Additional, fewer, or different operations may be performed in the method 1000 depending on the embodiment. At least one aspect of the operations is directed to a system, method, apparatus, or a computer-readable medium.

A wireless communication device (e.g., a UE) may receive a signal (e.g., a wake up signal (WUS)) from a wireless communication node (e.g., a BS). The wireless communication device may determine that information carried in the signal (e.g., paging occasion (PO) information, a group ID, or an identifier of a UE) matches specific information (e.g., associated with the wireless communication device). The wireless communication device may transition a radio from sleep state to wake-up state (e.g., to measure synchronization signal block (SSB) or to monitor physical downlink control channel (PDCCH) for paging message) in response to the determination.

In some embodiments, the information carried in the signal comprises information can be about a specific paging occasion (PO). The information about the specific PO may comprise: an index of a paging frame (PF), and an index of the specific PO in the PF. The information about the specific PO may comprise: an index of the specific PO in a discontinuous reception (DRX) cycle.

In some embodiments, the information carried in the signal comprises information can be about a specific identifier (group ID) of a group of wireless communication devices that includes the wireless communication device. The wireless communication node may allocate the group ID. The wireless communication node may send the group ID to the wireless communication device via radio resource control (RRC) signaling. The wireless communication node may send the group ID to a core network. A core network may send the group ID to the wireless communication node.

In some embodiments, the information carried in the signal may comprise information about a specific identifier (group ID) of a group of wireless communication devices that includes the wireless communication device. The group ID can be allocated by a core network (CN), for a CN controlled subgroup associated with a paging Early Indication (PEI) of the wireless communication device. The group ID can be determined, based on UE ID associated with the PEI of the wireless communication device.

In some embodiments, the information carried in the signal may comprise information about a specific identity of the wireless communication device, or a part of the specific identity. The specific identifier may comprise a serving temporary mobile subscriber identity (S-TMSI). The wireless communication node may allocate the specific identity, and may send the specific identity to the wireless communication device via radio resource control (RRC) signaling.

In some embodiments, the wireless communication device may receive, from the wireless communication node via the signal (e.g., low power wake up signal (LP-WUS)), a system information block (SIB) or radio resource control (RRC) signaling, configuration information of a paging occasion (PO) or physical downlink control channel (PDCCH) for the wireless communication device to monitor for paging. In certain embodiments, an additional PO and/or PUCCH may be received if specific PO is missed due to ramp-up time.

In some embodiments, the configuration information may comprise at least one of: an offset between a starting or ending time of the signal and a starting time of the PO or PDCCH, an offset between the starting or ending time of the signal and a starting time of a discontinuous reception (DRX) cycle, an offset between the starting or ending time of the signal and a starting time of a paging frame (PF), a duration of the PDCCH, an indication of a resource configured for the PO or PDCCH, an indication of a configuration for enabling the PO or PDCCH, carried in RRC or SIB signaling, an index of the PF, and an index of the PO in the PF, an index of the PO in the DRX cycle, an index of the PO in a PF, a system frame number (SFN) of the PF, and the index of the PO in the PF, the SFN of the PF, and a slot number of the PO, or a SFN of the PO, and the slot number of the PO. The LP-WUS may indicate a PO resource that the UE monitors. The LP-WUS may indicate a PDCCH resource for paging that the UE monitors.

In some embodiments, the DRX cycle can be a DRX cycle that is nearest to the time that the wireless communication device has completed transition to wake up state. The DRX cycle can be determined by a first offset time. The PF can be a PF that is nearest to the time that the wireless communication device has completed transition to wake up state. The PF can be determined by a second offset time. The PO can be a PO that is nearest to the time that the wireless communication device has completed transition to wake up state. The PO can be determined by a third offset time. The PO can be determined by the third offset time and an identity of the wireless communication device, and the PF can be shifted by the third offset time. The PDCCH can be a PDCCH that is nearest to the time that the wireless communication device has completed transition to wake up state. The PDCCH can be determined by a fifth offset time.

In some embodiments, the wireless communication device may receive, from the wireless communication node via the signal, information about a physical downlink shared channel (PDSCH) resource or downlink grant for PDSCH, for the wireless communication device to monitor for paging. The wireless communication device may receive, from the wireless communication node via the signal, a system information block (SIB) or radio resource control (RRC) signaling, an indicator to enable or disable the wireless communication device to monitor the PO or PDCCH for paging.

In some embodiments, the wireless communication device may monitor a separate PO or PDCCH for paging. The wireless communication device may monitor a separate PO for paging, if the wireless communication device fails to detect paging in the PO or PDCCH. The wireless communication device may transition into a deep sleep state, if the wireless communication device fails to detect paging after monitoring at least a defined number of POs.

In some embodiments, the wireless communication device may receive, from the wireless communication node via the signal, a system information block (SIB) or radio resource control (RRC) signaling, configuration information of a physical random access channel (PRACH) resource or a PRACH resource pool to be used for measurement of a synchronization block (SSB), after receiving the signal. The wireless communication device may select the PRACH resource from the PRACH resource pool, according to an index of the wireless communication device, the index included in a list of indices of wireless communication devices woken by the signal.

In some embodiments, if the wireless communication device is woken up by the signal, an access stratum (AS) may send an indication to a non-access stratum (NAS) that the wireless communication device is woken up by the signal. If a radio resource control (RRC) connection is triggered by the signal, the NAS may send to the AS an indication that mobile termination is triggered by the signal. The wireless communication device may send a msg3 to the wireless communication node, the msg3 indicating an establishment cause or establishment indication that mobile termination is triggered by the signal. The wireless communication node may send a msg4 to the wireless communication node, the msg4 indicating a rejection cause or rejection indication that the mobile termination is triggered by the signal. If the RRC connection is rejected, the AS may send an indication of the rejection cause or rejection indication to the NAS, to indicate that the wireless communication device is incorrectly woken up by the signal.

In some embodiments, the signal may include an indication that system information has been updated. The wireless communication device may send, to a core network (CN), an indication of a capability of the wireless communication device to operationally respond to the signal. The CN may send the indication of the capability to the wireless communication node.

In some embodiments, a wireless communication node (e.g., a BS) may send a signal (e.g., a WUS) to a wireless communication device (e.g., a UE). The wireless communication device may determine that information carried in the signal (e.g., paging occasion (PO) information, a group ID, or an identifier of a UE) matches specific information (e.g., associated with the wireless communication device). The wireless communication device may transition a radio from sleep state to wake-up state (e.g., to measure synchronization signal block (SSB) or to monitor physical downlink control channel (PDCCH) for paging message) in response to the determination.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a wireless communication device from a wireless communication node, a signal;
determining, by the wireless communication device, that information carried in the signal matches specific information; and
performing, by the wireless communication device in response to the determination, physical downlink control channel (PDCCH) monitoring for paging.

2. The method of claim 1, wherein at least one of:
the information carried in the signal comprises information about a specific identifier (group ID) of a group of wireless communication devices that includes the wireless communication device;
a core network allocates the group ID; or
the core network sends the group ID to the wireless communication node.

3. The method of claim 1, wherein at least one of:
the information carried in the signal comprises information about a specific identifier (group ID) of a group of wireless communication devices that includes the wireless communication device;
or the group ID is determined, based on a UE ID associated with a paging early indication (PEI) of the wireless communication device.

4. The method of claim 1, comprising:
receiving, by the wireless communication device from the wireless communication node via the signal, a system information block (SIB), a radio resource control (RRC) signaling, configuration information of a paging occasion (PO), or an indicator to enable or disable the wireless communication device to monitor the PO or a PDCCH for paging.

5. The method of claim 4, wherein the configuration information comprises an offset between a starting or ending time of the signal and a starting time of the PO or the PDCCH.

6. A wireless communication device comprising:
at least one processor configured to:
receive, via a receiver from a wireless communication node, a signal;
determine that information carried in the signal matches specific information; and
perform, in response to the determination, physical downlink control channel (PDCCH) monitoring for paging.

7. The wireless communication device of claim 6, wherein at least one of:
the information carried in the signal comprises information about a specific identifier (group ID) of a group of wireless communication devices that includes the wireless communication device;
a core network allocates the group ID; or
the core network sends the group ID to the wireless communication node.

8. The wireless communication device of claim 6, wherein at least one of:
the information carried in the signal comprises information about a specific identifier (group ID) of a group of wireless communication devices that includes the wireless communication device;
or the group ID is determined, based on a UE ID associated with a paging early indication (PEI) of the wireless communication device.

9. The wireless communication device of claim 6, comprising:
receiving, by the wireless communication device from the wireless communication node via the signal, a system information block (SIB), a radio resource control (RRC) signaling, configuration information of a paging occasion (PO), or an indicator to enable or disable the wireless communication device to monitor the PO or a PDCCH for paging.

10. The wireless communication device of claim 9, wherein the configuration information comprises an offset between a starting or ending time of the signal and a starting time of the PO or the PDCCH.

11. A method comprising:
sending, by a wireless communication node to a wireless communication device, a signal,
wherein the wireless communication device determines that information carried in the signal matches specific information associated with the wireless communication device, and performs, in response to the determination, physical downlink control channel (PDCCH) monitoring for paging.

12. The method of claim 11, wherein at least one of:
the information carried in the signal comprises information about a specific identifier (group ID) of a group of wireless communication devices that includes the wireless communication device;
a core network allocates the group ID; or
the core network sends the group ID to the wireless communication node.

13. The method of claim 11, wherein at least one of:
the information carried in the signal comprises information about a specific identifier (group ID) of a group of wireless communication devices that includes the wireless communication device; or
the group ID is determined, based on a UE ID associated with a paging early indication (PEI) of the wireless communication device.

14. The method of claim 11, comprising:
sending, by the wireless communication node to the wireless communication device via the signal, a system information block (SIB), a radio resource control (RRC) signaling, configuration information of a paging occasion (PO), or an indicator to enable or disable the wireless communication device to monitor the PO or a PDCCH for paging.

15. The method of claim 14, wherein the configuration information comprises an offset between a starting or ending time of the signal and a starting time of the PO or the PDCCH.

16. A wireless communication node comprising:
at least one processor configured to:
send, via a transmitter to a wireless communication device, a signal,
wherein the wireless communication device determines that information carried in the signal matches specific information, and performs, in response to the determination, physical downlink control channel (PDCCH) monitoring for paging.

17. The wireless communication node of claim 16, wherein at least one of:
the information carried in the signal comprises information about a specific identifier (group ID) of a group of wireless communication devices that includes the wireless communication device;
a core network allocates the group ID; or
the core network sends the group ID to the wireless communication node.

18. The wireless communication node of claim 16, wherein at least one of:
the information carried in the signal comprises information about a specific identifier (group ID) of a group of wireless communication devices that includes the wireless communication device;
or the group ID is determined, based on a UE ID associated with a paging early indication (PEI) of the wireless communication device.

19. The wireless communication node of claim 16, wherein the at least one processor is configured to:
send, via the transmitter to the wireless communication device via the signal, a system information block (SIB), a radio resource control (RRC) signaling, configuration information of a paging occasion (PO), or an indicator to enable or disable the wireless communication device to monitor the PO or a PDCCH for paging.

20. The wireless communication node of claim 19, wherein the configuration information comprises an offset between a starting or ending time of the signal and a starting time of the PO or the PDCCH.
